(19) United States
(12) Patent Application Publication
(10) Pub. No.: US 2017/0019908 A1
(43) Pub. Date: Jan. 19, 2017

(54) Method and System for Controlling Quality of Service of Sharing Network

(71) Applicant: Telefonaktiebolaget LM Ericsson (publ), Stockholm (SE)

(72) Inventors: Min Lou, Beijing (CN); Huaisong Zhu, Beijing (CN)

(21) Appl. No.: 15/104,621

(22) PCT Filed: Dec. 16, 2013
(86) PCT No.: PCT/CN2013/089526

§ 371 Date: Jun. 15, 2016

(51) Int. Cl. H04W 72/08; H04W 24/10; H04W 72/12; H04W 16/14

(52) U.S. Cl. CPC H04W 72/087; H04W 16/14; H04W 24/10; H04W 72/1242

(57) ABSTRACT

The embodiments disclose a method for controlling Quality of Service for a wireless communication network shared among operators. The method comprises: receiving a message, which includes radio resource measurement of an operator; calculating a radio resource utilization amount of the operator based on the radio resource measurement; comparing the radio resource utilization amount with a set value; and sending a request to adjust the radio resource utilization amount of the operator according to the comparing result. The embodiments also disclose a Quality of Service controlling system thereof.

### TECHNICAL FIELD

The present technology generally relates to wireless communication, particularly to a method for controlling quality of service for a wireless communication network shared among operators and the system thereof.

### BACKGROUND

Prior art that is related to this technical field can be found in, for example, the technical specification 3GPP TS 23.251, the technical specification 3GPP TS 22.951.

Network sharing is a way for operators to share the heavy deployment costs for mobile networks, e.g. in the roll-out phase. In the current mobile telephony marketplace, functionality that enables various forms of network sharing is becoming more and more important.

In 3GPP Release 6 (the Third Generation Partnership Project Sixth version) protocol, a network sharing technology is introduced to provide a radio resource sharing way to enable multiple sharing operators (i.e., the operators that do not have or use their own access network, but share at least one of others) to share an access network of a master operator (i.e., the operator that has its own access network shared by another operator) without those sharing operators deploying networks by themselves, thus saving costs.

A network sharing architecture allows different core network operators to connect to a shared radio access network. The operators do not only share the radio network elements, but may also share the radio resources themselves. The operators share a radio access network from other operators according to a lease contract. Master operators or sharing operators may use more network resources than committed percentage. This may cause unfair charges among sharing operators. This may also cause network traffic overload, and this in turn may result in network performance degradation and thus bad user experience.

### SUMMARY

Therefore, it is an object to solve at least one of the above-mentioned problems.

According to one aspect of the embodiments, there is provided a method for controlling Quality of Service for a wireless communication network shared among operators. The method comprises: receiving a message, which includes radio resource measurement of an operator; calculating a radio resource utilization amount of the operator based on the radio resource measurement; comparing the radio resource utilization amount with a set value; and sending a request to adjust the radio resource utilization amount of the operator according to the comparing result.

According to another aspect of the embodiments, there is provided a method performed in a radio network entity for a wireless communication network shared among operators. The method comprises: sending a message, which includes radio resource measurement of an operator for calculating a radio resource utilization amount of the operator; receiving a request to adjust the radio resource utilization amount of the operator; adjusting the radio resource utilization amount of the operator according to the request.

According to another aspect of the embodiments, there is provided a Quality of Service controlling system for a wireless communication network shared among operators. The system comprises a receiving unit, a calculating unit, a comparing unit and a sending unit. The receiving unit is configured to receive a message, which includes radio resource measurement of an operator; the calculating unit is configured to calculate a radio resource utilization amount of the operator based on the radio resource measurement; the comparing unit is configured to compare the radio resource utilization amount with a set value; and the sending unit is configured to send a request to adjust the radio resource utilization amount of the operator according to the comparing result.

According to another aspect of the embodiments, there is provided a radio network entity for a wireless communication network shared among operators. The radio network entity comprises a sending unit, a receiving unit and an adjusting unit. The sending unit is configured to send a message, which includes radio resource measurement of an operator for calculating a radio resource utilization amount of the operator; the receiving unit is configured to receive a request to adjust the radio resource utilization amount of the operator; the adjusting unit is configured to adjust the radio resource utilization amount of the operator according to the request.

According to another aspect of the embodiments, there is provided a wireless communication network shared among operators. The wireless communication network comprises the Quality of Service controlling system and the radio network entity described above.

According to a further aspect of the embodiments, there is provided a computer program product, which comprises the instructions stored on a non-transitory storage medium, when executed in a processor, implementing the steps of the methods as described above.

According to a still further aspect of the embodiments, there is provided a non-transitory storage medium which stores instructions for implementing the steps of the methods as described above.

According to yet a further aspect of the embodiments there is provided a network device, for a wireless communication network shared among operators. The network device comprises a memory and a processing system. The memory is configured to store instructions therein; the processing system is configured to execute the instructions. When the instructions are executed in the processing system, the steps of the methods as described above are implemented.

As a whole or by scenario, it is advantageous to introduce cooperation between the RAN and the OAM. The OAM can then monitor and adjust resource consumption status of the shared network.

### BRIEF DESCRIPTION OF THE DRAWINGS

The technology will now be described, by way of example, based on embodiments with reference to the accompanying drawings, wherein:

FIG. 1 illustrates a schematic view of the environment in which embodiments are implemented;

FIG. 2 illustrates a flowchart of a method performed in a Quality of Service, QoS, controlling system in accordance with one embodiment;

FIG. 3 illustrates a flowchart of a method performed in a radio network entity in accordance with one embodiment;

FIG. 4 illustrates a block diagram of a QoS controlling system in accordance with one embodiment;

FIG. 5 illustrates a block diagram of a radio network entity in accordance with one embodiment;

FIG. 6 is a block diagram illustrating example physical components of a network device.

### DETAILED DESCRIPTION

Embodiments herein will be described in detail hereinafter with reference to the accompanying drawings, in which embodiments are shown. This embodiments herein may, however, be embodied in many different forms and should not be construed as being limited to the embodiments set forth herein. The elements of the drawings are not necessarily to scale relative to each other. Like numbers refer to like elements throughout.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

The present technology is described below with reference to block diagrams and/or flowchart illustrations of methods, apparatus (systems) and/or computer program products according to the present embodiments. It is understood that blocks of the block diagrams and/or flowchart illustrations, and combinations of blocks in the block diagrams and/or flowchart illustrations, may be implemented by computer program instructions. These computer program instructions may be provided to a processor, controller or controlling unit of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

Accordingly, the present technology may be embodied in hardware and/or in software (including firmware, resident software, micro-code, etc.). Furthermore, the present technology may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that may contain, store, communicate, propagate, or transport the program for use by or in connection with the instruction execution system, apparatus, or device.

Embodiments herein will be described below with reference to the drawings.

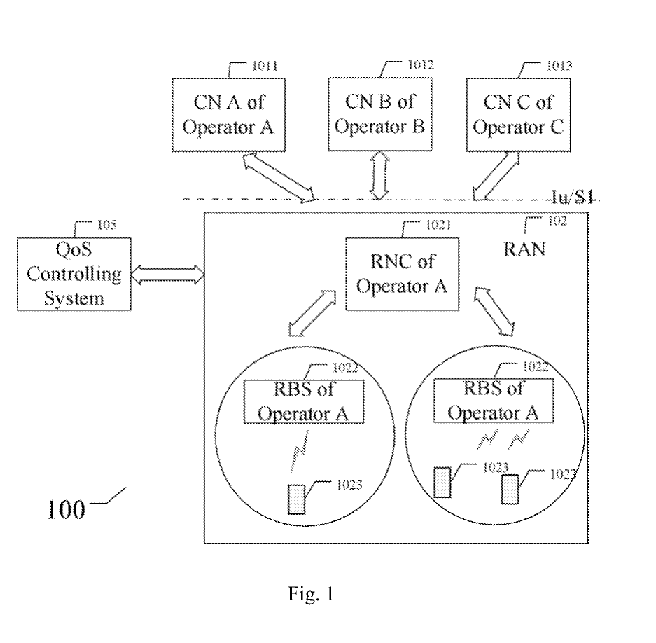

Hereinafter, the embodiments will be described mainly with reference to architecture in FIG. 1. However, such description is only exemplary, rather than restrictive, and the embodiments are also applicable to other types of network which exist for the present or will exist in the future as appropriate.

Wireless communication network 100 includes two or more core networks (CNs). For sake of simplicity, the wireless communication network 100 of FIG. 1 is shown with only three CNs: CN A of operator A 1011, CN B of operator B 1012, CN C of operator C 1013. Wireless communication network 100 also includes one or more Radio Access Network, RAN. For sake of simplicity, the wireless communication network 100 of FIG. 1 is shown with only one RAN 102. The RAN 102 includes one or more radio network controllers (RNCs). For sake of simplicity, the wireless communication network 100 of FIG. 1 is shown with only one RNC node, RNC of Operator A 1021. The RNC of Operator A 1021 is connected to a plurality of radio base stations (RBSs). For example, and again for sake of simplicity, two RBSs, RBSs of operator A 102 are shown, each connected to the RNC of operator A 1021. Wireless communication network 100 also includes a Quality of Service (QoS), controlling system 105. It will be appreciated that a different number of RBSs can be served by the RNC. Moreover, FIG. 1 shows that a RNC of operator A 102 can be connected over an Iu/S1 interface to one or more CNs in the wireless communication network 100.

Here, the connections between RNC of operator A 1021 and RBSs of operator A 1022, between the RNC of operator A 1021 and the QoS controlling system 105, and between the RBSs of operator A 1022 and the QoS controlling system 105 may be implemented in a wired or wireless way, or combination thereof.

Further, those skilled in the art will also appreciate that RAN covers a geographical area which is divided into cell areas, with each cell area being served by a RBS. A cell is a geographical area where radio coverage is provided by the radio base station equipment at a base station site. The RBSs communicate over the air interface (e.g., radio frequencies) with one or more User Equipment(s), UEs, within range of the RBSs. In the RAN, several RBSs are typically connected (e.g., by landlines or microwave) to a RNC. The RNC, also sometimes termed a base station controller (BSC), supervises and coordinates various activities of the plural base stations connected thereto.

One example of a RAN is the Universal Mobile Telecommunications (UMTS) Terrestrial Radio Access Network (UTRAN). The UMTS is a third generation system which in some respects builds upon the radio access technology known as Global System for Mobile communications, GSM developed in Europe. UTRAN is essentially a radio access network providing Wideband Code Division Multiple Access, WCDMA, to UEs.

Further, those skilled in the art will also appreciate that a radio base station (RBS) is sometimes also referred to in the art as a base station, a macro base station, a femto base stations, a node B, or B-node, a eNodeB, etc., besides, also other transceivers or wireless communication stations used to communicate with the UEs.

In the illustrated environment, for sake of simplicity, each RBS of operator A 1022 is shown as serving one cell. Each cell is represented by a circle which surrounds the respective RBS. It will be appreciated by those skilled in the art, however, that a RBS of operator A 1022 may serve for communicating across the air interface for more than one cell. For example, two cells may utilize resources situated at the same RBS site.

A UE, such as a UE 1023 shown in FIG. 1, communicates with one or more cell(s) or one or more RBS(s) of operator A 1022 over a radio or an air interface. For simplicity and clarity, there are sets of 1, and 2 UE(s), each in a cell respectively. It will be appreciated that different numbers of UEs may be served by cells and the numbers served by different cells need not to be identical. The term “UE” used herein may indicate all forms of devices enabled to communicate via a communication network, such as mobile telephones (“cellular” telephones) and laptops with mobile termination, and thus can be, for example, portable, pocket, hand-held devices, such as mobile phones, smart phones, personal digital assistants (PDA); computer-included devices, such as desktops, laptops; vehicles, or other devices, such as meters, household appliances, medical appliances, multimedia devices, etc., which communicate voice and/or data with radio access network.

Those skilled in the art would also know a CN, is the central part of a telecommunication network that provides various services to customers who are connected by the access network. Typically the term refers to the high capacity communication facilities that connect primary nodes. Core network provides paths for the exchange of information between different sub-networks.

In one embodiment, the QoS controlling system 105 is part of an Operation, Administration, and Maintenance (OAM) system of operator A. Alternatively, it resides, partly or wholly, on an Operation Support System (OSS) of the O&M system.

According to 3GPP Release 8, CN A of operator A 1011 will send a QoS profile including parameters governing the QoS to the RAN 102. The parameters for each operator may be different according to their lease contract. Upon receiving the QoS profile, RNC of operator A 1021 will map the parameters in the QoS profile into scheduling priorities of radio resource management, actually based on which radio resource is allocated.

In 3GPP Release 8, the parameters governing the QoS include QoS class identifier (QCI), guaranteed bit rate (GBR), maximum bit rate (MBR), aggregate maximum bit rate (AMBR) and allocation retention policy (ARP). ARP is primarily used to determine whether a service bearer for the service can be established (i.e., decide whether the service to the UE can be provided) When there are resource limitations (such as too many UEs vying for connections) from the network. GBR and MBR denote the bit rate and the maximum bit rate that can be expected to be provided by a GBR bearer. AMBR limits the aggregate bit rate that can be expected to be provided by all Non-GBR service bearers of a UE sharing a same PDN connection.

According to 3GPP release 8, RAN 102 side can statically set different mapping methods for operators A, B and C from QoS profile from CN of operator A 1011 to priority schedule. But this mapping is unaware of current radio resource utilization.

In prior art, RAN 102 will always try to fully fulfill all the CNs, i.e., CN of operator A, CN of operator B and CN or operator C, until resources run out in RAN. In an LTE system, basic element of QoS control is a bearer, i.e., all data on the same bearer will get the same QoS guarantee, different types of bearers offer different QoSs. If not all bearers can be satisfied, RAN 102 should (or can only) simply trigger a deactivation of those bearers according to the priority schedule. This passive way is unexpected. On the other hand, optionally, the OSS of an operator can collect network status in case that congestion occurs, and the CN of the operator can adjust radio resource utilization of the operator accordingly. However, the CN cannot adjust radio resource utilization of other operators, due to CNs of different operators keep secret from each other on their QoS policy. The resource consumption amount of any or all operator(s), i.e., operator A, operator B and/or operator C, are unknown to the CN.

However, in embodiments of the present application, the QoS controlling system 105 can detect radio resource utilization amount of different operators, or further, can adapt the radio resource utilization amount of different operators dynamically.

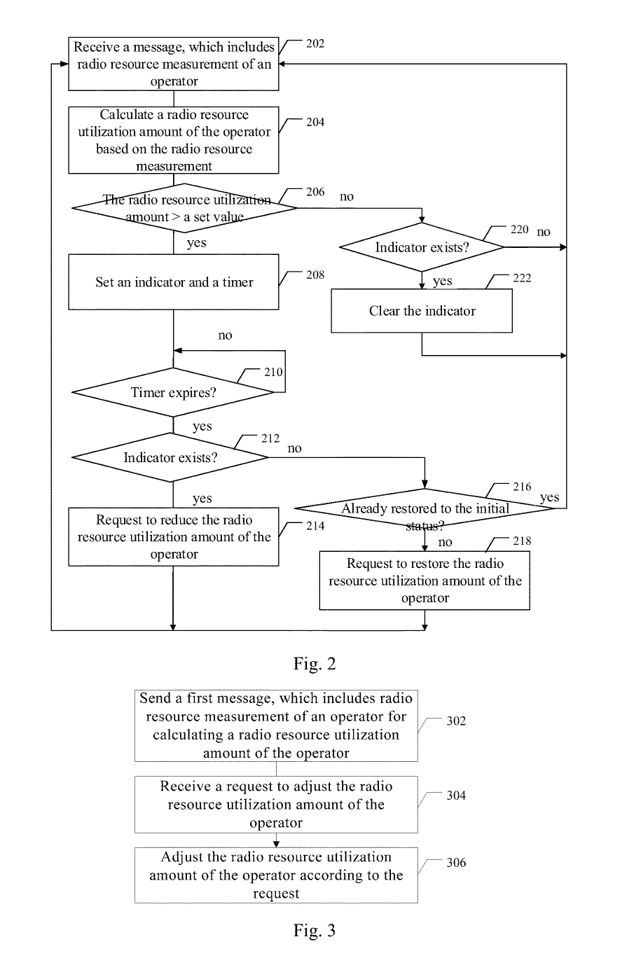

FIG. 2 illustrates a flowchart of a method performed in a QoS controlling system in accordance with one embodiment. In step 202, the QoS controlling system 105 receives a message, which includes radio resource measurement of an operator, for example, operator B. In one example, the message is a self-defined message. The radio resource measurement of an operator may be at least one of, or combination of the following related to operator B: connection status (for example, idle or active), radio resources such as bandwidth consumption (in a LTE system, it is specified as uplink or downlink occupied physical resource block divided by system total physical resource block, and in a UMTS system, it is specified as used code amount divided by available code amount), downlink transmission power (for example, power consumed by a RBS to transmit data to some UE), uplink interference (for example, power of data received from some UE at a RBS), etc., latency (for example, average latency of a traffic type of some UE), and traffic throughput (for example, bit per second of a RBS). Optionally, the message is received on a regular basis.

It should be appreciated that the above message are described by way of example, and any suitable message that can carry radio resource measurement of an operator, for example, a signaling message between QoS controlling system 105 and any radio network entity in the RAN 102 can be used in this embodiment. It should be appreciated that the above types of measurement are described by way of example, and any suitable measurement that can reflect radio resource utilization status of an operator can be used in this embodiment. The message is not necessarily sent from a RBS of operator A 1022, but may also from the RNC of operator A 1021, or from any other network entity, as long as it can collect the radio resource measurement of an operator.

It should also be appreciated that what kind of measurement is needed is determined based on the lease contract between a master operator, i.e., operator A, and a sharing operator, i.e., operator B and/or operator C. The lease contract specifies an amount or ratio of resources that can be used by a sharing operator in a shared network, for example, the RAN 102. If the contract specifies, for example, operator B can only share 20% of total active connections, then the measurement should at least contain connection status. For another example, if the contract specifies operator B can only share 20% of downlink transmission power, then the measurement should at least contain downlink transmission power.

In step 204, the QoS controlling system 105 calculates a radio resource utilization amount of, for example, operator B, based on the received radio resource measurement. The radio resource utilization amount comprises at least one of the following related to operator B: active connection number, average latency, total traffic throughput, total bandwidth consumption, total downlink transmission power consumption, and total uplink interference.

It should be appreciated that the radio resource utilization amount corresponds to the measurement received in step 202, and apparently, also corresponds to the lease contract. For example, if the lease contract specifies the limit of active connection number in a RBS, then the radio resource utilization amount is calculated for every RBS; if the lease contract specifies the limit of active connection number in a RAN, then the radio resource utilization amount is calculated for the RAN.

In step 206, the QoS controlling system 105 compares the radio resource utilization amount of, for example, operator B, with a set value. In one example, the set value is predetermined according to the lease contract.

In one embodiment, it is determined that the radio resource utilization amount of, for example, operator B is larger than a set value, then an indicator is set to show this. This is shown in step 208.

It should be appreciated that the indicator could be rephrased similarly, for example, alarm, as long as it functions similarly.

Optionally, an observation window could be set, for the QoS controlling system of operator A 105 to wait for a duration before actions being taken in response to the indicator. In one example, the observation window is set by way of setting a timer at the same time the indicator is set. This is also shown in step 208.

It should be appreciated that the indicator and the observation window could be set in another way, for example, the indicator is set only after a duration that the radio resource utilization amount of, for example, operator B, keeps larger than a set value, and actions in response to the indicator are taken immediately after the indicator is set.

In the embodiment, the timer and the indicator are then checked (in step 210 and step 212 respectively). If the timer expires, and the indicator still exists, in step 214, the QoS controlling system 105 will send a request to reduce the radio resource utilization amount of the operator. In one example, the way to reduce the radio resource utilization amount of, for example, operator B could be to decrease scheduling priorities of the operator by a certain level.

As is described with reference to FIG. 1, CN A of operator A 1011 has sent a QoS profile including parameters governing the QoS to the RAN 102. The parameters for each operator may be different according to their lease contract. Upon receiving the QoS profile, RNC of operator A 1021 has mapped the parameters in the QoS profile into scheduling priorities of radio resource management, actually based on which radio resource is allocated. The scheduling priorities of radio resource management may be listed as in Table 1:

TABLE 1

| Scheduling priority | Operator A | Operator B |
|---|---|---|
| 1 | voice | voice |
| 2 | | |
| 3 | Live Streaming | |
| | with High GBR | |
| 4 | Live Streaming | Live Streaming |
| | with low GBR | with High GBR |
| 5 | | Live Streaming |
| | | with low GBR |
| 6 | Real Time Gaming | Real Time Gaming |
| 7 | IMS signaling | IMS signaling |
| 8 | | |
| 9 | | |
| 10 | Normal TCP/IP | Normal TCP/IP |
| 11 | | |
| 12 | | |

. . .

It should be appreciated that Table 1 is just by way of an example, and any level number of scheduling priority can be classified, and scheduling priorities for different types of traffic can be assigned according to different mapping between the parameters in the QoS profile and scheduling priorities of radio resource management.

In one embodiment, after step 214, scheduling priorities may be adapted from Table 1 to Table 2:

TABLE 2

| Scheduling priority | Operator A | Operator B |
|---|---|---|
| 1 | voice | |
| 2 | | voice |
| 3 | Live Streaming | |
| | with High GBR | |
| 4 | Live Streaming | |
| | with low GBR | |
| 5 | | Live Streaming |
| | | with High GBR |
| 6 | Real Time Gaming | Live Streaming |
| | | with low GBR |
| 7 | IMS signaling | Real Time Gaming |
| 8 | | IMS signaling |
| 9 | | |
| 10 | Normal TCP/IP | |
| 11 | | Normal TCP/IP |
| 12 | | |

. . .

It can be seen from Table 2 that scheduling priority of every type of traffic of operator B is decreased by one level.

It should be appreciated that any other way to reduce the radio resource utilization amount of, for example, operator B could also be applied, for example, simply deactivating some traffic type, for example, live streaming with high GBR, of operator B.

Optionally, the exact way to reduce the radio resource utilization amount of, for example, operator B could be specified in the request sent in step 214, and could alternately be determined by a radio network entity that creates such tables.

If the situation is not alleviated after taking step 214, i.e., the actual ratio of resources in the RAN 102 still exceeds that specified in the lease contract, those steps described above could be repeated in a second round, third round, etc. For example, if the radio resource utilization amount is still larger than the set value in the second round, scheduling priorities may be further adapted from table 2 to Table 3:

TABLE 3

| Scheduling priority | Operator A | Operator B |
|---|---|---|
| 1 | voice | |
| 2 | | |
| 3 | Live Streaming | voice |
| | with High GBR | |
| 4 | Live Streaming | |
| | with low GBR | |
| 5 | | |
| 6 | Real Time Gaming | Live Streaming |
| | | with High GBR |
| 7 | IMS signaling | Live Streaming |
| | | with low GBR |
| 8 | | Real Time Gaming |
| 9 | | IMS signaling |
| 10 | Normal TCP/IP | |
| 11 | | |
| 12 | | Normal TCP/IP |

. . .

It can be seen from Table 3 that scheduling priority of every type of traffic of operator B is decreased by one level.

If the timer expires, and otherwise the indicator does not exist, the QoS controlling system 105 will request to restore the radio resource utilization amount of, for example, operator B. This is shown in step 218.

Optionally, the way to restore the radio resource utilization amount of, for example, operator B could just be reverse to the way to reduce it. For example, if in the first round, scheduling priorities are adapted from Table 1 to Table 2 as requested, and in the second round, scheduling priorities are adapted from Table 2 to Table 3 as requested, and thus the situation is finally alleviated, then in the third round, scheduling priorities are adapted from Table 3 to Table 2 as requested.

In one embodiment, those steps taken are not in the initial round, and then in step 216 before step 218, the QoS controlling system 105 will check whether, for example, Table 1 has reached its initial status. If it has, the QoS controlling system 105 will proceed to step 202 of the next round. If it has not, it will then proceed to step 218.

In one embodiment, a counting parameter can be set, and increase by 1, in case that step 214 is taken, and decrease by 1 in case that step 218 is taken. Step 218 can only be taken if the counting parameter is not of its initial value.

In another embodiment, in step 206, it is determined that the radio resource utilization amount of, for example, operator B is not lager than a set value, then in step 222, the QoS controlling system 105 clears the indicator if it detects there is any (step 220).

Optionally, all the steps mentioned above with reference to FIG. 2 could be performed in an OSS. Optionally, steps 210, 212, 214, 216 and 218 are performed in a radio network entity internal or external to the OSS.

It should be appreciated that not only network sharing of operator B can be monitored and adapted dynamically, but also that of operator A or C can, at the same time, or at a different time, although network sharing of operator A could be adjusted in the prior art when congestion occurs, as is described with reference to FIG. 1.

The order in which some or all of the steps appear in each embodiment should not necessarily be deemed limiting. Rather, it should be understood by a person of ordinary skill in the art having the benefit of the instant disclosure that some of the step blocks may be executed in a variety of orders not illustrated.

As a whole, by means of cooperation between the RAN and the OAM, the OAM can be conscious of the resource consumption status of the shared network, for example, the RAN 102, among operators, for example, operator A and/or operator B and/or operator C. As a result, the OAM can be able to adjust radio resource allocation or scheduling among master and sharing operators dynamically, to restrict the operators to their limited ratio of network sharing respectively. The restriction is not necessarily carried only when congestion occurs and is not necessarily initiated only by the CN as opposed to the prior art. Besides, network resource exhaustion, performance degradation and user experience worsening can be obviated far earlier before occurring, due to the operators being restricted from occupying too much resources of the shared network, according to a reasonable lease contract.

FIG. 3 illustrates a flowchart of a method performed in a radio network entity in accordance with one embodiment.

In step 302, a radio network entity sends a message, which includes radio resource measurement of an operator for calculating a radio resource utilization amount of the operator, for example, operator B. In one example, the message is a self-defined message. The radio resource measurement of an operator may be at least one of, or combination of the following related to operator B: connection status (for example, idle or active), radio resources such as bandwidth consumption (in a LTE system, it is specified as uplink or downlink occupied physical resource block divided by system total physical resource block, and in a UMTS system, it is specified as used code amount divided by available code amount), downlink transmission power (for example, power consumed by a RBS to transmit data to some UE), uplink interference (for example, power of data received from some UE at a RBS), etc., latency (for example, average latency of a traffic type of some UE), and traffic throughput (for example, bit per second of a RBS). Optionally, the message is received on a regular basis.

It should be appreciated that the above message are described by way of example, and any suitable message that can carry radio resource measurement of an operator, for example, a signaling message between QoS controlling system 105 and any radio network entity in the RAN 102 can be used in this embodiment. It should be appreciated that the above types of measurement are described by way of example, and any suitable measurement that can reflect radio resource utilization status of an operator can be used in this embodiment.

It should be appreciated that the network entity is not necessarily the RBS of operator A 1022, but may also be the RNC of operator A 1021, or any other network entity, be it internal or external to another entity, as long as it can collect the radio resource measurement of an operator.

It should also be appreciated that what kind of measurement is needed is determined based on the lease contract between master operator, i.e., operator A, and a sharing operator, i.e., operator B and/or operator C. The lease contract specifies an amount or ratio of resources that can be used by a sharing operator in a shared network, for example, the RAN 102. If the contract specifies, for example, operator B can only share 20% of total active connections, then the measurement should at least contain connection status. For another example, if the contract specifies operator B can only share 20% of downlink transmission power, then the measurement should at least contain downlink transmission power.

After a short or long time, the network entity may receive a request to adjust the radio resource utilization amount of the operator. This is shown in step 304.

In one embodiment, the request is a request to reduce the radio resource utilization amount of the operator, for example, operator B. In another embodiment, the request is a request to restore the radio resource utilization amount of the operator, for example, operator B.

Then in step 306, the radio network entity adjusts the radio resource utilization amount of the operator, for example, operator B, according to the request.

In one example, the way to reduce the radio resource utilization amount of, for example, operator B, could be to decrease scheduling priorities of the operator by a certain level, as is described with reference to FIG. 2 above, wherein in one example, Table 1, Table 2 and Table 3 is created and maintained in the network entity, It should be appreciated that it can also be created and/or maintained in some other entity that connects to it.

Optionally, the exact way to reduce the radio resource utilization amount of, for example, operator B, could be specified in the request received in step 304, and could alternately be determined by a radio network entity that creates such tables.

Optionally, the way to restore the radio resource utilization amount of, for example, operator B could just be reverse to the way to reduce it, as is also described with reference to FIG. 2.

As a whole, by means of cooperation between the RAN and the OAM, the OAM can be conscious of the resource consumption status of the shared network, for example, the RAN 102, among operators, for example, operator A and/or operator B and/or operator C. As a result, the OAM can be able to adjust radio resource allocation or scheduling among master and sharing operators dynamically, to restrict the operators to their limited ratio of network sharing respectively. The restriction is not necessarily carried only when congestion occurs and is not necessarily initiated only by the CN as opposed to the prior art. Besides, network resource exhaustion, performance degradation and user experience worsening can be obviated far earlier before occurring, due to the operators being restricted from occupying too much resources of the shared network, according to a reasonable lease contract.

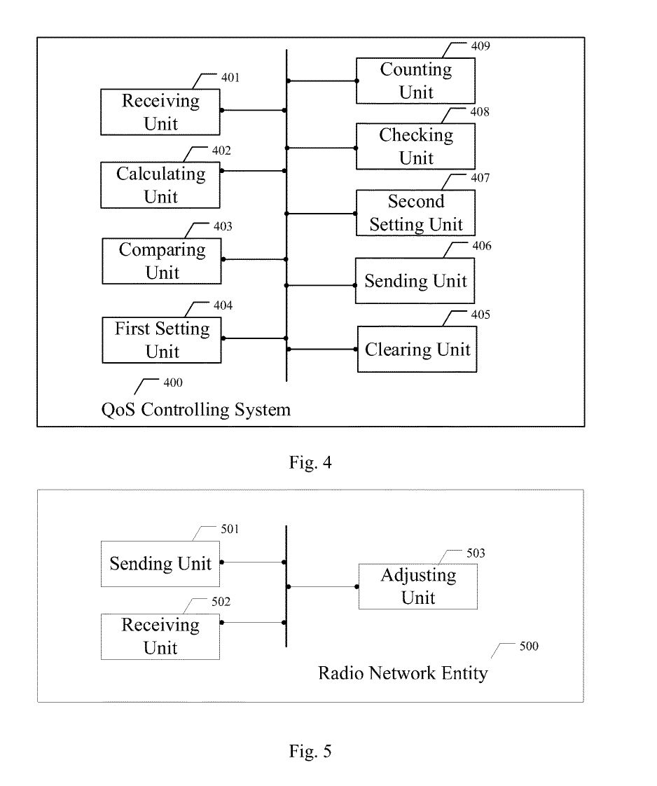

FIG. 4 illustrates a block diagram of a QoS controlling system in accordance with one embodiment. In FIG. 4, the QoS controlling system 105 comprises at least a receiving unit 401, a calculating unit 402, a comparing unit 403, and a sending unit 406. It should be appreciated that the QoS controlling system 105 is not limited to the shown elements, and can comprise other conventional elements and the additional elements implemented for other purposes.

The receiving unit 401 is configured to receive a message, which includes radio resource measurement of an operator. The calculating unit 402 is configured to calculate a radio resource utilization amount of the operator based on the radio resource measurement. The comparing unit 403 is configured to compare the radio resource utilization amount with a set value. The sending unit 406 is configured to send a request to adjust the radio resource utilization amount of the operator according to the comparing result.

Additionally or alternatively, the QoS controlling system 105 further comprises a first setting unit 404 and a clearing unit 405. The first setting unit 404 is configured to set an indicator before sending the request to reduce the radio resource utilization amount of the operator after the radio resource utilization amount is larger than the set value for a duration. The clearing unit 405 is configured to clear the indicator after the radio resource utilization amount is reduced to be not larger than the set value for a duration.

Additionally or alternatively, the QoS controlling system 105 further comprises a second setting unit 407 and a checking unit 408. The second setting unit 407 is configured to set a timer when the indicator is set. The checking unit 408 is configured to check the indicator when the timer expires.

Additionally or alternatively, the QoS controlling system 105 further comprises a counting unit 409. The counting unit 409 is used to count the times of a type of requests sending from the sending unit 406.

Specifically or optionally, the second setting unit 407, the checking unit 408, the sending unit 406 and the counting unit 409 may reside in an entity apart from the other units shown in FIG. 4.

The units shown above are illustrated as separate units in FIG. 4. However, this is merely to indicate that the functionalities are separated. The units can be provided as separate hardware devices. However, other arrangements are possible. Any combination of the units can be implemented in any combination of software, hardware, and/or firmware in any suitable location. For example, there could be more systems of the same functionalities working together, implemented locally or distributed among several devices coupled together through network, with each system having one or more of the units (e.g., comparing unit, calculating unit, etc.) shown.

The units may constitute machine-executable instructions embodied within a machine, e.g., readable medium, which when executed by a machine will cause the machine to perform the operations described. Besides, any of the units may be implemented as a hardware, such as an application specific integrated circuit (ASIC), Digital Signal Processor (DSP), Field Programmable Gate Array (FPGA) or the like.

Besides, it should be understood that this and other arrangements described herein are set forth only as examples. Other arrangements and units (e.g., user interface, more comparing unit, calculating unit, etc.) can be used in addition to or instead of those shown, and some units may be omitted altogether.

Functionalities and cooperation between these units are described in detail in the following.

Firstly, the receiving unit 401 receives a message, which includes radio resource measurement of an operator, for example, operator B. In one example, the message is a self-defined message. The radio resource measurement of an operator may be at least one of, or combination of the following related to operator B: connection status (for example, idle or active), radio resources such as bandwidth consumption (in a LTE system, it is specified as uplink or downlink occupied physical resource block divided by system total physical resource block, and in a UMTS system, it is specified as used code amount divided by available code amount), downlink transmission power (for example, power consumed by a RBS to transmit data to some UE), uplink interference (for example, power of data received from some UE at a RBS), etc., latency (for example, average latency of a traffic type of some UE), and traffic throughput (for example, bit per second of a RBS). Optionally, the message is received on a regular basis.

It should be appreciated that the above message are described by way of example, and any suitable message that can carry radio resource measurement of an operator, for example, a signaling message between QoS controlling system 105 and any radio network entity in the RAN 102 can be used in this embodiment. It should be appreciated that the above types of measurement are described by way of example, and any suitable measurement that can reflect radio resource utilization status of an operator can be used in this embodiment. The message is not necessarily sent from a RBS of operator A 1022, but may also from the RNC of operator A 1021, or from any other network entity, as long as it can collect the radio resource measurement of an operator.

It should also be appreciated that what kind of measurement is needed is determined based on the lease contract between a master operator, i.e., operator A, and a sharing operator, i.e., operator B and/or operator C. The lease contract specifies an amount or ratio of resources that can be used by a sharing operator in a shared network, for example, the RAN 102. If the contract specifies, for example, operator B can only share 20% of total active connections, then the measurement should at least contain connection status. For another example, if the contract specifies operator B can only share 20% of downlink transmission power, then the measurement should at least contain downlink transmission power.

Afterwards, the calculating unit 402 calculates a radio resource utilization amount of, for example, operator B, based on the received radio resource measurement. The radio resource utilization amount comprises at least one of the following related to operator B: active connection number, average latency, total traffic throughput, total bandwidth consumption, total downlink transmission power consumption, and total uplink interference.

It should be appreciated that the radio resource utilization amount corresponds to the measurement received by the receiving unit 401, and apparently, also corresponds to the lease contract. For example, if the lease contract specifies the limit of active connection number in a RBS, then the radio resource utilization amount is calculated for every RBS; if the lease contract specifies the limit of active connection number in a RAN, then the radio resource utilization amount is calculated for the RAN.

Afterwards, the comparing unit 403 compares the radio resource utilization amount of, for example, operator B, with a set value. In one example, the set value is predetermined according to the lease contract.

In one embodiment, it is determined that the radio resource utilization amount of, for example, operator B is larger than a set value, then an indicator is set to show this. This is performed in the first setting unit 404.

It should be appreciated that the indicator could be rephrased similarly, for example, alarm, as long as it functions similarly.

Optionally, an observation window could be set, for the QoS controlling system of operator A 105 to wait for a duration before actions being taken in response to the indicator. In one example, the observation window is set by way of setting a timer at the same time the indicator is set. This is performed in the second setting unit 407.

It should be appreciated that the indicator and the observation window could be set in another way, for example, the indicator is set only after a duration that the radio resource utilization amount of, for example, operator B, keeps larger than a set value, and actions in response to the indicator are taken immediately after the indicator is set.

In the embodiment, the timer and the indicator are then checked (in checking unit 408). If the timer expires, and the indicator still exists, then the sending unit 406 will send a request to reduce the radio resource utilization amount of the operator. In one example, the way to reduce the radio resource utilization amount of, for example, operator B could be to decrease scheduling priorities of the operator by a certain level.

As is described with reference to FIG. 1, CN A of operator A 1011 has sent a QoS profile including parameters governing the QoS to the RAN 102. The parameters for each operator may be different according to their lease contract. Upon receiving the QoS profile, RNC of operator A 1021 has mapped the parameters in the QoS profile into scheduling priorities of radio resource management, actually based on which radio resource is allocated. The scheduling priorities of radio resource management may be listed as in Table 1 as mentioned above.

It should be appreciated that Table 1 is just by way of an example, and any level number of scheduling priority can be classified, and scheduling priorities for different types of traffic can be assigned according to different mappings between the parameters in the QoS profile and scheduling priorities of radio resource management.

In one embodiment, after the sending unit 406 sends the request to reduce the radio resource utilization amount of the operator, scheduling priorities may be adapted from Table 1 to Table 2 as mentioned above.

It can be seen from Table 2 that scheduling priority of every type of traffic of operator B is decreased by one level.

It should be appreciated that any other way to reduce the radio resource utilization amount of, for example, operator B could also be applied, for example, simply deactivating some traffic type, for example, live streaming with high GBR, of operator B.

Optionally, the exact way to reduce the radio resource utilization amount of, for example, operator B could be specified in the request sent by the sending unit 406, and could alternately be determined by a radio network entity that creates such tables.

If the situation is not alleviated after the sending unit 406 sends the request to reduce the radio resource utilization amount of the operator, i.e., the actual ratio of resources in the RAN 102 still exceeds that specified in the lease contract, those steps described above could be repeated in a second round, third round, etc. For example, if the radio resource utilization amount is still larger than the set value in the second round, scheduling priorities may be further adapted from table 2 to Table 3 as mentioned above.

It can be seen from Table 3 that scheduling priority of every type of traffic of operator B is decreased by one level.

If the timer expires, and otherwise the indicator does not exist, the sending unit 406 will request to restore the radio resource utilization amount of, for example, operator B.

Optionally, the way to restore the radio resource utilization amount of, for example, operator B could just be reverse to the way to reduce it. For example, if in the first round, scheduling priorities are adapted from Table 1 to Table 2 as requested, and in the second round, scheduling priorities are adapted from Table 2 to Table 3 as requested, and thus the situation is finally alleviated, then in the third round, scheduling priorities are adapted from Table 3 to Table 2 as requested.

In one embodiment, the counting unit 409 increases a counting parameter by 1, in case that the sending unit 406 sends a request to reduce the radio resource utilization amount of a particular operator, and decreases by 1 in case that the sending unit 406 sends a request to restore the radio resource utilization amount of a particular operator. The sending unit 406 can only send the request to restore the radio resource utilization amount of a particular operator if the counting parameter is not of its initial value.

In another embodiment, if the comparing unit 403 determines that the radio resource utilization amount of, for example, operator B is not lager than a set value, then the clearing unit clears the indicator if it detects there is any.

Optionally, all the units mentioned above with reference to FIG. 4 could be performed in an OSS. Optionally, the second setting unit 407, the checking unit 408, the sending unit 406 and the counting unit 409 may reside in an entity located in a radio network entity internal or external to the OSS.

As a whole, by means of cooperation between the RAN and the OAM, the OAM can be conscious of the resource consumption status of the shared network, for example, the RAN 102, among operators, for example, operator A and/or operator B and/or operator C. As a result, the OAM can be able to adjust radio resource allocation or scheduling among master and sharing operators dynamically, to restrict the operators to their limited ratio of network sharing respectively. The restriction is not necessarily carried only when congestion occurs and is not necessarily initiated only by the CN as opposed to the prior art. Besides, network resource exhaustion, performance degradation and user experience worsening can be obviated far earlier before occurring, due to the operators being restricted from occupying too much resources of the shared network, according to a reasonable lease contract.

FIG. 5 illustrates a block diagram of a radio network entity in accordance with one embodiment. In FIG. 5, the radio network entity 500 comprises a sending unit 501, a receiving unit 502 and a adjusting unit 503. It should be appreciated that the radio network entity 500 is not limited to the shown elements, and can comprise other conventional elements and the additional elements implemented for other purposes.

The sending unit 501 is configured to send a message, which includes radio resource measurement of an operator for calculating a radio resource utilization amount of the operator. The receiving unit 502 is configured to receive a request to adjust the radio resource utilization amount of the operator. The adjusting unit 503 is configured to adjust the radio resource utilization amount of the operator according to the request.

The units 501-503 are illustrated as separate units in FIG. 5. However, this is merely to indicate that the functionalities are separated. The units can be provided as separate hardware devices. However, other arrangements are possible. Any combination of the units can be implemented in any combination of software, hardware, and/or firmware in any suitable location. For example, there could be more system working together, implemented locally or distributed among several devices coupled together through network, with each system having one or more of the units (e.g., adjusting unit, etc.) shown.

The units may constitute machine-executable instructions embodied within a machine, e.g., readable medium, which when executed by a machine will cause the machine to perform the operations described. Besides, any of the units may be implemented as a hardware, such as an application specific integrated circuit (ASIC), Digital Signal Processor (DSP), Field Programmable Gate Array (FPGA) or the like.

Besides, it should be understood that this and other arrangements described herein are set forth only as examples. Other arrangements and units (e.g., user interface, more adjusting unit, etc.) can be used in addition to or instead of those shown, and some units may be omitted altogether.

Functionalities and cooperation between these units are described in detail in the following.

Firstly the sending unit 501 sends a message, which includes radio resource measurement of an operator for calculating a radio resource utilization amount of the operator, for example, operator B. In one example, the message is a self-defined message. The radio resource measurement of an operator may be at least one of, or combination of the following related to operator B: connection status (for example, idle or active), radio resources such as bandwidth consumption (in a LTE system, it is specified as uplink or downlink occupied physical resource block divided by system total physical resource block, and in a UMTS system, it is specified as used code amount divided by available code amount), downlink transmission power (for example, power consumed by a RBS to transmit data to some UE), uplink interference (for example, power of data received from some UE at a RBS), etc., latency (for example, average latency of a traffic type of some UE), and traffic throughput (for example, bit per second of a RBS). Optionally, the message is received on a regular basis.

It should be appreciated that the above message are described by way of example, and any suitable message that can carry radio resource measurement of an operator, for example, a signaling message between QoS controlling system 105 and any radio network entity in the RAN 102 can be used in this embodiment. It should be appreciated that the above types of measurement are described by way of example, and any suitable measurement that can reflect radio resource utilization status of an operator can be used in this embodiment.

It should be appreciated that the network entity is not necessarily the RBS of operator A 1022, but may also be the RNC of operator A 1021, or any other network entity, be it internal or external to another entity, as long as it can collect the radio resource measurement of an operator.

It should also be appreciated that what kind of measurement is needed is determined based on the lease contract between master operator, i.e., operator A, and a sharing operator, i.e., operator B and/or operator C. The lease contract specifies an amount or ratio of resources that can be used by a sharing operator in a shared network, for example, the RAN 102. If the contract specifies, for example, operator B can only share 20% of total active connections, then the measurement should at least contain connection status. For another example, if the contract specifies operator B can only share 20% of downlink transmission power, then the measurement should at least contain downlink transmission power.

After a short or long time, the network entity may receive a request to adjust the radio resource utilization amount of the operator. This is performed in the receiving unit 502.

In one embodiment, the request is a request to reduce the radio resource utilization amount of the operator, for example, operator B. In another embodiment, the request is a request to restore the radio resource utilization amount of the operator, for example, operator B.

Then the adjusting unit 503 adjusts the radio resource utilization amount of the operator, for example, operator B, according to the request.

In one example, the way to reduce the radio resource utilization amount of, for example, operator B, could be to decrease scheduling priorities of the operator by a certain level, as is described with reference to FIG. 2 above, wherein in one example, Table 1, Table 2 and Table 3 is created and maintained in the network entity, It should be appreciated that it can also be created and/or maintained in some other entity that connects to it.

Optionally, the exact way to reduce the radio resource utilization amount of, for example, operator B, could be specified in the request received by the receiving unit 502, and could alternately be determined by a radio network entity that creates such tables.

Optionally, the way to restore the radio resource utilization amount of, for example, operator B could just be reverse to the way to reduce it, as is also described with reference to FIG. 2.

As a whole, by means of cooperation between the RAN and the OAM, the OAM can be conscious of the resource consumption status of the shared network, for example, the RAN 102, among operators, for example, operator A and/or operator B and/or operator C. As a result, the OAM can be able to adjust radio resource allocation or scheduling among master and sharing operators dynamically, to restrict the operators to their limited ratio of network sharing respectively. The restriction is not necessarily carried only when congestion occurs and is not necessarily initiated only by the CN as opposed to the prior art. Besides, network resource exhaustion, performance degradation and user experience worsening can be obviated far earlier before occurring, due to the operators being restricted from occupying too much resources of the shared network, according to a reasonable lease contract.

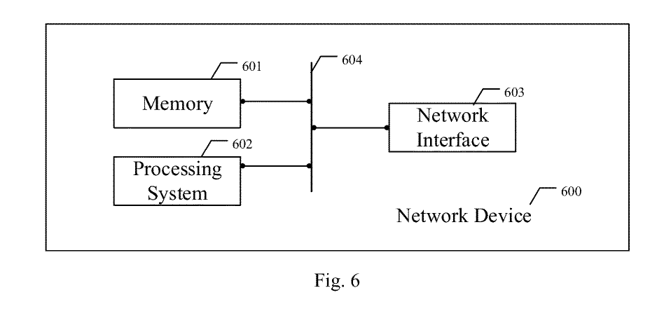

FIG. 6 is a block diagram illustrating example physical components of a network device 600. The radio network entity, QoS controlling system, and other network devices in the wireless communication network 100 can have components similar to those of the network device 600. It should be appreciated that these network devices can be implemented using network devices having components other than those illustrated in the example of FIG. 6.

In the example of FIG. 6, the network device 600 comprises a memory 601, a processing system 602, a network interface 603, and a communication medium 604. The memory 601 includes one or more computer-usable or computer-readable storage medium capable of storing data and/or computer-executable instructions. Is should be appreciated that the storage medium is preferably a non-transitory storage medium.

The processing system 602 includes one or more processing units. A processing unit is a physical device or article of manufacture comprising one or more integrated circuits that read data and instructions from computer readable media, such as the memory 601, and selectively execute the instructions. In various embodiments, the processing system 602 is implemented in various ways. For example, the processing system 602 can be implemented as one or more processing cores. In another example, the processing system 602 can comprise one or more separate microprocessors. In yet another example embodiment, the processing system 602 can comprise an application-specific integrated circuit (ASIC) that provides specific functionality. In yet another example, the processing system 602 provides specific functionality by using an ASIC and by executing computer-executable instructions.

The network interface 603 is a device or article of manufacture that enables the network device 600 to send data to and receive data from a communication network. In different embodiments, the network interface 603 is implemented in different ways. For example, the network interface 603 can be implemented as an Ethernet interface, a token-ring network interface, a fiber optic network interface, a wireless network interface (e.g., Wi-Fi, WiMax, etc.), or another type of network interface.

The communications medium 604 facilitates communication among the hardware components of the network device 600. In the example of FIG. 6, the communications medium 604 facilitates communication among the memory 601, the processing system 602, and the network interface 603. The communications medium 604 can be implemented in various ways. For example, the communications medium 604 can comprise a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 601 stores various types of data and/or software instructions. For instance, in the example of FIG. 6, the instructions in the memory 601 can include those that when executed in the processing system, cause the network device 600 to implement the methods described herein.

While the embodiments have been illustrated and described herein, it will be understood by those skilled in the art that various changes and modifications may be made, and equivalents may be substituted for elements thereof without departing from the true scope of the present technology. In addition, many modifications may be made to adapt to a particular situation and the teaching herein without departing from its central scope. Therefore it is intended that the present embodiments not be limited to the particular embodiment disclosed as the best mode contemplated for carrying out the present technology, but that the present embodiments include all embodiments falling within the scope of the appended claims.

1-28. (canceled)

29. A method for controlling Quality of Service (QoS) for a wireless communication network shared among operators, comprising:
receiving a message, which includes radio resource measurement of an operator;
calculating a radio resource utilization amount of the operator based on the radio resource measurement;
comparing the radio resource utilization amount with a set value; and
sending a request to adjust the radio resource utilization amount of the operator according to the comparing result.

30. The method of claim 29, wherein the sending step comprises:
sending a request to reduce the radio resource utilization amount of the operator when the radio resource utilization amount is larger than the set value.

31. The method of claim 30, wherein the sending step further comprises:
sending a request to restore the radio resource utilization amount of the operator after the radio resource utilization amount is reduced to be not larger than the set value, until it is determined that the operator's initial status is reached.

32. The method of claim 31, further comprising:
setting an indicator before sending the request to reduce the radio resource utilization amount of the operator after the radio resource utilization amount is larger than the set value for a duration; and
clearing the indicator after the radio resource utilization amount is reduced to be not larger than the set value for a duration.

33. The method of claim 32, further comprising:
setting a timer when the indicator is set;
checking the indicator when the timer expires;
sending a request to decrease scheduling priorities of the operator in case that the indicator exists; and otherwise,
sending a request to increase the scheduling priorities of the operator until it reaches its initial priorities, in case that the indicator does not exist.

34. The method of claim 29, wherein the radio resource measurement comprises at least one of: connection status, bandwidth consumption, downlink transmission power, uplink interference, latency, traffic throughput.

35. The method of claim 29, wherein the radio resource utilization amount comprises at least one of: active connection number, total bandwidth consumption, total downlink transmission power consumption, total uplink interference, average latency, total traffic throughput.

36. The method of claim 29, wherein adjusting the radio resource utilization amount of the operator comprises adjusting scheduling priorities of the operator.

37. A method performed in a radio network entity, for a wireless communication network shared among operators, comprising:
sending a message, which includes radio resource measurement of an operator for calculating a radio resource utilization amount of the operator;
receiving a request to adjust the radio resource utilization amount of the operator;
adjusting the radio resource utilization amount of the operator according to the request.

38. The method of claim 37, wherein the request comprises one of: a request to reduce the radio resource utilization amount of the operator, and a request to restore the radio resource utilization amount of the operator.

39. The method of claim 37, wherein the radio resource measurement comprises at least one of: connection status, bandwidth consumption, downlink transmission power, uplink interference, latency, traffic throughput.

40. The method of claim 37, wherein adjusting the radio resource utilization amount of the operator comprises adjusting scheduling priorities of the operator.

41. A Quality of Service (QoS) controlling system for a wireless communication network shared among operators, comprising:
a receiving unit, configured to receive a message, which includes radio resource measurement of an operator;
a calculating unit, configured to calculate a radio resource utilization amount of the operator based on the radio resource measurement;
a comparing unit, configured to compare the radio resource utilization amount with a set value; and
a sending unit, configured to send a request to adjust the radio resource utilization amount of the operator according to the comparing result.

42. The system of claim 41, wherein the sending unit is further configured to send a request to reduce the radio resource utilization amount of the operator when the radio resource utilization amount is larger than the set value.

43. The system of claim 42, wherein the sending unit is further configured to send a request to restore the radio resource utilization amount of the operator after the radio resource utilization amount is reduced to be not larger than the set value.

44. The system of claim 43, further comprising:
a first setting unit, configured to set an indicator before sending the request to reduce the radio resource utilization amount of the operator after the radio resource utilization amount is larger than the set value for a duration; and
a clearing unit, configured to clear the indicator after the radio resource utilization amount is reduced to be not larger than the set value for a duration.

45. The system of claim 44, further comprising:
a second setting unit, configured to set a timer when the indicator is set;
a checking unit, configured to check the indicator when the timer expires;
a counting unit, configured to determine whether the operator reaches its initial status; and
the sending unit is further configured to send a request to decrease scheduling priorities of the operator in case that the indicator exists; and otherwise, send a request to increase the scheduling priorities of the operator until it reaches its initial priorities in case that the indicator does not exist.

46. The system of claim 41, wherein the radio resource measurement comprises at least one of: connection status, bandwidth consumption, downlink transmission power, uplink interference, latency, traffic throughput.

47. The system of claim 41, wherein radio resource utilization amount comprises one or more of: an active connection number, a total bandwidth consumption, a total downlink transmission power consumption, a total uplink interference, an average latency, and a total traffic throughput.

48. The system of claim 41, wherein the request to adjust the radio resource utilization amount of the operator comprises a request to adjust scheduling priorities of the operator.
